(19) United States
(12) Patent Application Publication
(10) Pub. No.: US 2010/0098421 A1
(43) Pub. Date: Apr. 22, 2010

(54) Optical interface method and apparatus

(75) Inventor: Sunao Itou, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/654,261

(22) Filed: Dec. 15, 2009

Related U.S. Application Data
(63) Continuation of application No. PCT/JP2007/062801, filed on Jun. 26, 2007.

(51) Int. Cl. H04J 14/00; H04B 10/00

(52) U.S. Cl. 398/76; 398/163

(57) ABSTRACT

An optical interface method includes producing a digital wrapper signal by synchronizing a client signal that is inputted via an optical transmission channel with an oscillating frequency of a fixed oscillator; returning the digital wrapper signal back into the client signal; and outputting the client signal obtained from the digital wrapper signal by the returning onto the optical transmission channel. The oscillating frequency of the fixed oscillator is set higher than a frequency of the client signal in the optical transmission channel.

### CROSS-REFERENCE TO RELATED APPLICATIONS

This application is a U.S. continuation application filed under 35 USC 111(a) claiming benefit under 35 USC 120 and 365(c) of PCT application JP2007/062801, filed Jun. 26, 2007. The foregoing application is hereby incorporated herein by reference.

### FIELD

The present invention relates to an optical interface method and apparatus for synchronizing a client signal inputted via an optical transmission channel with an oscillating frequency of a fixed oscillator in an optical interface apparatus to produce a digital wrapper signal, and for returning the digital wrapper signal back into the original client signal and outputting it onto the optical transmission channel.

### BACKGROUND

It has been discussed in connection with a digital communications technology that pulse or bit stuffing may be performed for synchronizing and multiplexing digital signals generated by multiple apparatuses. Stuffing synchronization involves storing the digital signals in a memory and then reading them out using a common clock signal having a slightly higher rate than the rates of the signals that are to be multiplexed, thus converting the rates of the individual signals into a common rate. The difference between each digital signal and the clock signal is compensated for by inserting extra (“stuffing”) pulses or bits as necessary.

A stuffing synchronization communication apparatus for use in a satellite communication system for international digital communications has also been discussed, in which standard clocks of various countries are used.

Patent Document 1: Japanese Laid-Open Patent Application No. 11-355236

### SUMMARY

The object and advantages of the disclosure will be realized and attained by means of the elements and combinations particularly pointed out in the claims.

It is to be understood that both the foregoing general description and the following detailed description are exemplary and explanatory and are not restrictive of the invention as claimed.

According to one aspect of the present invention, an optical interface method includes producing a digital wrapper signal by synchronizing a client signal that is inputted via an optical transmission channel with an oscillating frequency of a fixed oscillator; returning the digital wrapper signal back into the client signal; and outputting the client signal obtained from the digital wrapper signal by the returning onto the optical transmission channel. The oscillating frequency of the fixed oscillator is set higher than a frequency of the client signal in the optical transmission channel.

According to another aspect of the present invention, an optical interface apparatus includes a fixed oscillator configured to generate an oscillating frequency; and a digital wrapper unit configured to produce a digital wrapper signal by synchronizing a client signal inputted via an optical transmission channel with the oscillating frequency generated by the fixed oscillator, and configured to return the digital wrapper signal back to the client signal that is outputted onto the optical transmission channel. The oscillating frequency of the fixed oscillator is set higher than a frequency of the client signal on the optical transmission channel.

According to yet another aspect of the present invention, an optical interface apparatus includes an oscillator configured to generate an oscillating frequency; a digital wrapper configured to produce a digital wrapper signal by synchronizing a client signal inputted via an optical transmission channel with the oscillating frequency of the oscillator, and configured to return the digital wrapper back into the client signal that is outputted onto the optical transmission channel; a frequency detection unit configured to detect a frequency of the client signal inputted via the optical transmission channel; and an oscillating frequency varying unit configured to vary the oscillating frequency of the oscillator depending on the frequency of the client signal detected by the frequency detection unit. The oscillating frequency of the oscillator is set to be higher than the frequency of the client signal on the optical transmission channel.

### BRIEF DESCRIPTION OF THE DRAWINGS

FIG. 1 depicts a block diagram of a WDM (wavelength division multiplex) apparatus;

FIG. 2 depicts a block diagram of an optical interface unit 10b of the WDM apparatus depicted in FIG. 1;

FIG. 3 depicts a frame structure for multiplexing four channels of 2.48832 Gb/s client signals into an OTU2;

FIG. 4 depicts a frame structure for multiplexing four channels of 9.95328 Gb/s client signals into an OUT3;

FIG. 5 depicts a frame structure for digitally wrapping one channel of a 2.48832 Gb/s client signal into an OTU1;

FIG. 6 depicts a frame structure for digitally wrapping one channel of a 9.95328 Gb/s client signal into an OTU2;

FIG. 7 depicts a graph illustrating the gain-frequency characteristics of a PLL circuit of the optical interface unit of FIG. 2;

FIG. 8 depicts a block diagram of an optical interface unit 10a of the WDM apparatus depicted in FIG. 1;

FIG. 9 depicts a block diagram of an optical interface unit according to a first embodiment of the present invention;

FIG. 10 illustrates a method of setting a fixed oscillator according to the first embodiment;

FIG. 11 depicts a block diagram of an optical interface unit according to a second embodiment of the present invention; and

FIG. 12 depicts a block diagram of an optical interface unit according to a third embodiment of the present invention.

### DESCRIPTION OF EMBODIMENTS

First, backgrounds of the embodiments of the present invention will be discussed.

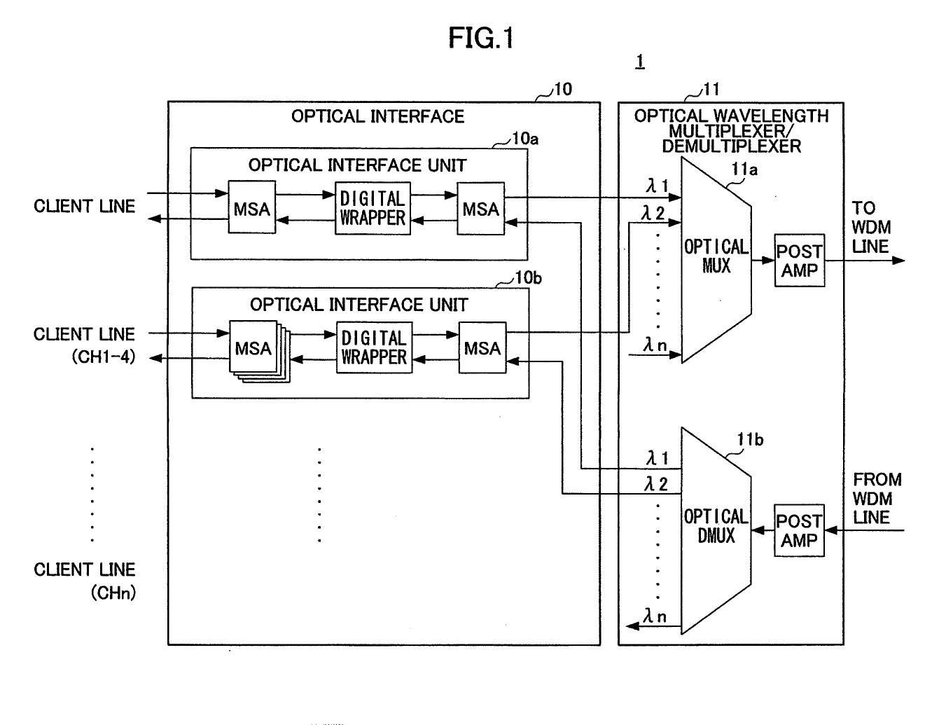

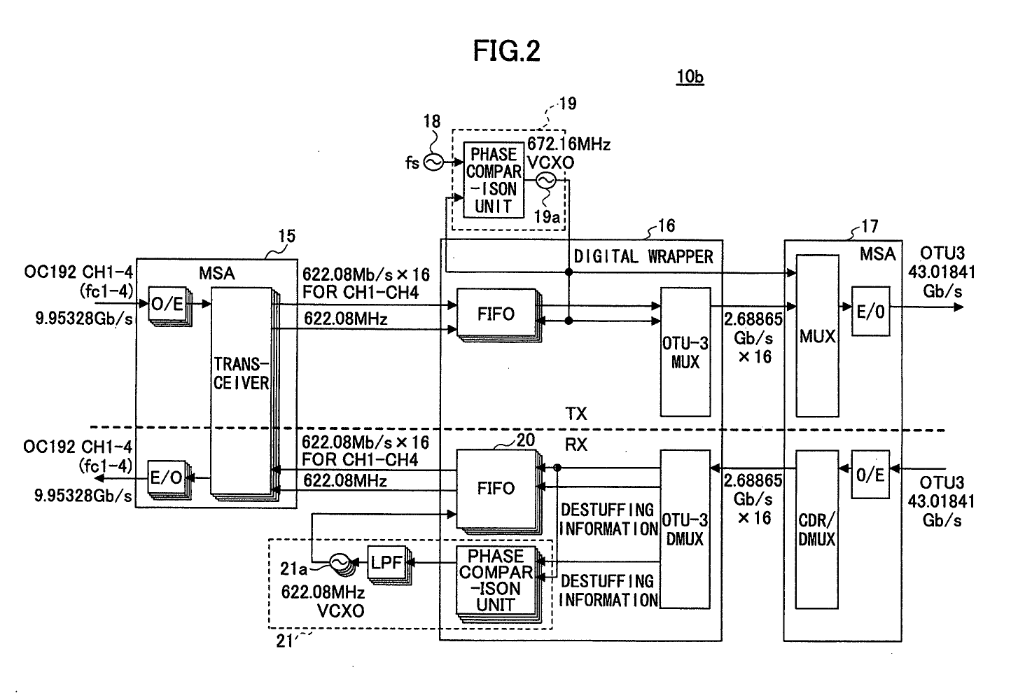

FIG. 1 depicts a block diagram of a wavelength division multiplexing (WDM) apparatus 1. The WDM apparatus 1 includes an optical interface apparatus 10 and a wavelength division multiplex/ demultiplex apparatus 11. The optical interface apparatus 10 includes optical interface units 10a and 10b. FIG. 2 depicts a block diagram of the optical interface unit 10b. The optical interface unit 10a performs digital wrapping of one channel of a client signal and its inverse conversion. The optical interface unit 10b performs digital wrapping of four channels of client signals and their inverse conversion.

An optical signal obtained by digital wrapping in the optical interface unit 10a or 10b is optically multiplexed by an optical multiplexing unit 11a in the wavelength division multiplex/ demultiplex apparatus 11. The optically multiplexed signal is then outputted onto a WDM line. An optically multiplexed signal received via another WDM line is demultiplexed into individual optical wavelengths by an optical demultiplexing unit 11b, and the separated signals are supplied to the optical interface units 10a and 10b.

Referring to FIG. 2, four channels (CH1-CH4) of the client signals, which are asynchronous to one another, are supplied to an MSA (Multi Source Agreement) 15 of the optical interface unit 10b. The client signals are then multiplexed in a digital wrapper 16 in synchronism with a clock outputted by an oscillator (VCXO) 19a in a PLL (phase-locked loop) 19 at the transmitting end (“TX”). At this time, a difference between each of the frequencies (fc1, fc2, fc3, fc4) of the individual client signals and a frequency (fs) outputted by the oscillator 19a of the PLL 19, which is synchronized with a clock of a fixed oscillator 18, is compensated for by stuffing synchronization. For example, when fs>f1, because the amount of data of f1 is small, excess bits (stuffing bits) are inserted.

On the other hand, at a receiving end (“RX”) in the digital wrapper 16 to which an optical signal is supplied from the wavelength division multiplex/demultiplex apparatus 11 via an MSA 17, the excess bits (stuffing bits) are removed by a FIFO 20 to restore the original signal, in a process referred to as “destuffing”. From the FIFO 20, the client signal is read using a clock outputted by an oscillator (VCXO) 21a of a PLL 21 and then supplied to the MSA 15.

The multiplex/demultiplex system according to an embodiment of the present invention relates to the digital wrapper defined by the ITU-T G.709 (Interfaces for the optical transport network=OTN).

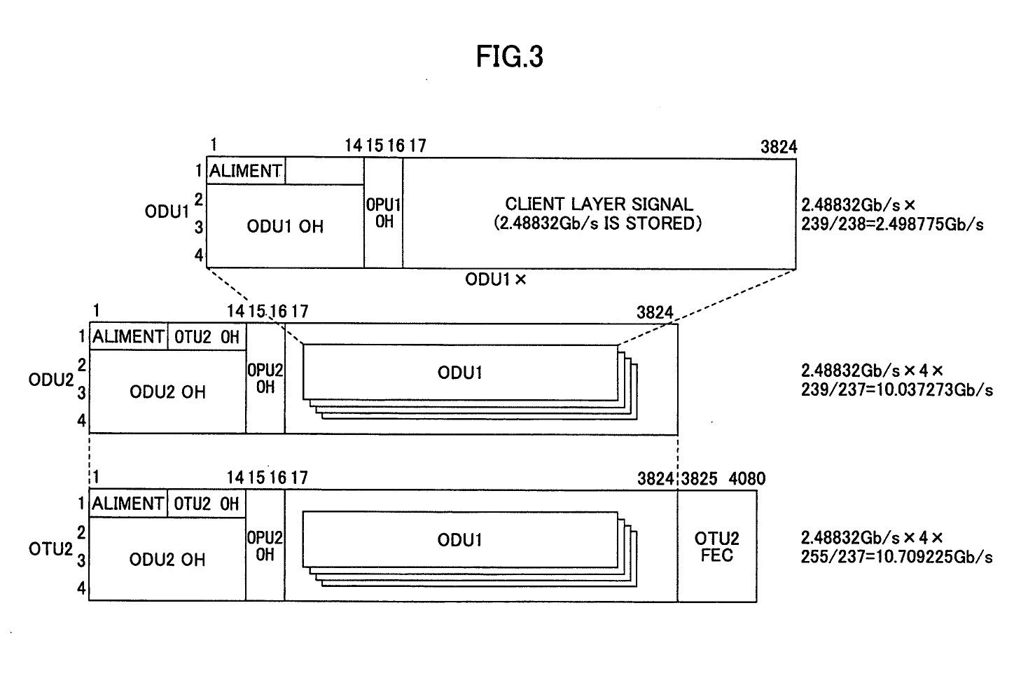

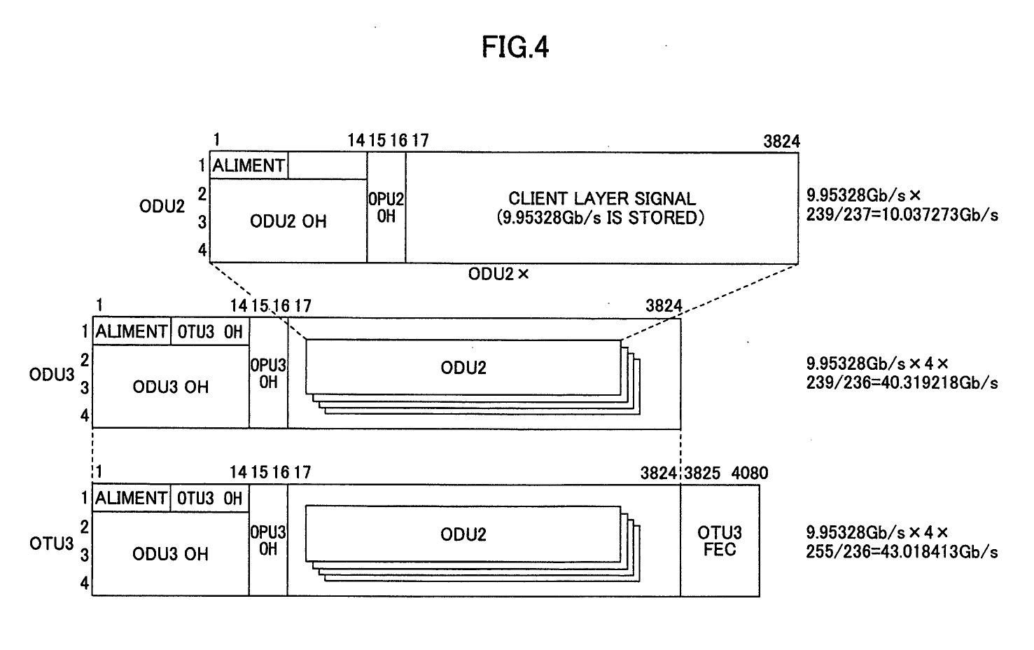

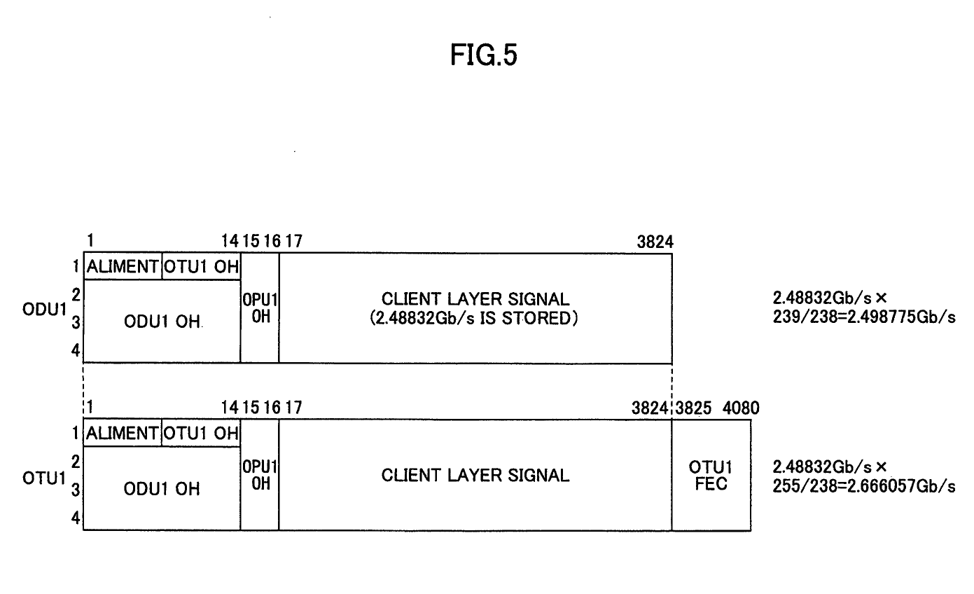

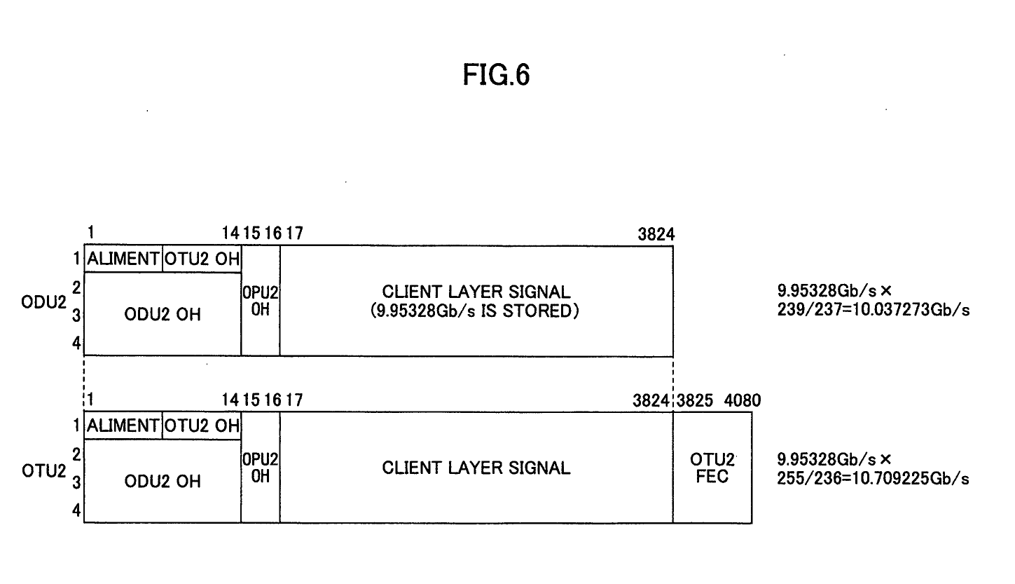

FIG. 3 depicts a frame structure for multiplexing four channels of 2.48832 Gb/s client signals into an OTU2 (Optical channel Transport Unit 2). FIG. 4 depicts a frame structure for multiplexing four channels of 9.95328 Gb/s client signals into an OTU3. FIG. 5 depicts a frame structure for digitally wrapping one channel of a 2.48832 Gb/s client signal into an OTU1. FIG. 6 depicts a frame structure for digitally wrapping one channel of a 9.95328 Gb/s client signal into an OTU2.

The transmission rates of 2.48832 Gb/s and 9.95328 Gb/s correspond to the frequencies of 2.48832 GHz and 9.95328 GHz, respectively (The same principle also applies to other transmission rates and frequencies hereinafter).

For example, when the 9.95328 Gb/s optical signal depicted in FIG. 4 is digitally wrapped, the signal is stored in a payload area of an ODU2 (Optical channel Data Unit 2) having a higher transfer rate of 9.95328 Gb/sx239/237. The increase in transfer rate is due to the addition of an OH (Overhead). In the OTU3, the transfer rate is further increased by the addition of FEC (Forward Error Correction) bytes, to 9.95328 Gb/sx255/236. The OH and FEC bytes are added at the transmitting end and are removed at the receiving end.

In a case of asynchronous clock transfer, NJO (Negative Justification Opportunity) and PJO (Positive Justification Opportunity) bytes in the OH of an OPU (Optical channel Payload Unit) are used. For example, when the client frequency is high, the amount of data is large; therefore, the data is stored in both the NJO and PJO bytes. When the client frequency is low, the amount of data is small; thus, justification bytes (zeros) are inserted (stuffed) into both the NJO and PJO bytes, for example.

In the case of the optical interface unit 10b that performs multiplexing and demultiplexing, the frequencies fc1 through fc4 of the client signals each have a frequency deviation within ±20 ppm (parts per million) in accordance with the ITU-T definitions. The frequency fs of the fixed oscillator 18 also has a frequency deviation within ±20 ppm due to environmental changes, such as temperature changes in a power supply, and aging. Depending on the combination of the deviation in fc1 through fc4 and the deviation in the fixed oscillator frequency fs, a deviation within ±40 ppm may be caused. The signs “±”, “+”, and “−” of the deviations are with respect to a zero deviation. For example, the frequency of 2.48832 GHz or 9.95328 GHz has a deviation of 0 ppm.

When the client signal ODUj (j=1 for ODU1) is to be stored in ODUk (k=2 for ODU2), and when N is a fixed number of stuffing bytes in an OPUk (payload area) of ODUk, S is a nominal ODUj rate (bits/sec), T is a nominal ODUk frame time (sec), yc is a frequency offset (ratio: ppm) of the client signal, ys is a frequency offset (ratio: ppm) of a server signal (i.e., an asynchronous clock signal for multiplexing), and p is a ratio of the payload area of ODUk that can be utilized by the client signal, an average number Nf of bytes of the client signal in the case of certain frequency offsets (which are averaged for a number of frames) is given by the following equation (1):

Nf=ST(1+yc)/(1+ys) (1)

When the frequency offsets are small relative to 1, equation (1) may be approximated by the following equation (2):

$$\begin{matrix}Nf = ST ( 1 + yc - ys ) \\ = ST β\end{matrix} \qquad ( 2 )$$

where (⊕−1) is an offset between the client signal frequency and the server signal frequency.

The average number Nf of bytes in the client signal that is mapped onto the ODUk frame is equal to a total number of bytes in the payload area that is available to the client signal (4×3.808xp=15.232xp) minus the number of the fixed stuffing bytes (N) for the client signal plus an average number of bytes stuffed in the client signal over a number of frames. The latter is equal to a stuffing ratio α multiplied by p, which is the ratio of frames corresponding to stuffing opportunities of the client signal. Combining this with equation (2) yields equation (3)

STβ=αp+15232p−N (3)

### <First Asynchronous Mapping>

When 2.48832 Gb/s is mapped onto ODU1 and further four channels are multiplexed in ODU2, 2.48832 Gb/s is mapped onto ODU1 while remaining in slave synchronization, and then the four channels of ODU1 are multiplexed in ODU2 using an asynchronous server frequency.

S=2.48832 Gb/sx239/238

T=3824×4/(4×2.48832 Gb/sx239/237)

where 3824×4 is the frame length of ODU2.

p=0.25(the ratio is 0.25 because the payload of ODU2 is divided into four parts)

N=0(ODU1 has no fixed stuffing bytes)

Substituting the above into equation (3) yields the following:

2.48832 Gb/sx239/238×3824×4/(4×2.48832 Gb/sx239/237)×β=α/4+3808

In the case of multiplexing, the fixed stuffing byte number N=0.

Thus,

239/238/(239/237)×3824×β=α/4+3808

237/238×3824×β=α/4+3808

Thus, the stuffing ratio α is as follows:

$$\begin{matrix}α = ( 237 / 238 \times 3824 \times β - 3808 ) \times 4 \\ = 237 / 238 \times 15296 \times β - 15232\end{matrix}$$

$$When β = 1 + y , \\ \begin{matrix}α = 237 / 238 \times 15296 - 237 / 238 \times 15296 \times y - 15232 \\ = - 0.2689076 + 15231.731092 \times y\end{matrix}$$

$$When α = 0 , \\ \begin{matrix}y = 0.2689076 / 15231.731092 \\ = 1.76544 \times 1 {e}^{- 5}\end{matrix}$$

Thus, α=0 (zero-stuffing) when the client signal frequency offset is 17.65 ppm.

### <Second Asynchronous Mapping>

When 9.95328 Gb/s is mapped onto ODU2 and four channels are multiplexed in ODU3, 9.95328 Gb/s is mapped onto ODU2 while remaining in slave synchronization and then the four channels of ODU2 are multiplexed in ODU3 using the frequency of an asynchronous server.

S=9.95328 Gb/sx239/237

T=3824×4/(4×9.95328 Gb/sx239/236)

where 3824×4 is the frame length of ODU2.

p=0.25 (the ratio is 0.25 because the payload of OPU3 is divided into four parts)

N=0(ODU1 has no fixed stuffing byte)

Substituting the above into equation (3) yields the following:

9.95328 Gb/sx239/237×3824×4/(4×9.95328 Gb/sx239/236)×β=α/4+3808

In the case of multiplexing, the fixed stuffing byte number N=0.

Thus,

239/237/(239/236)×3824×β=α/4+3808

236/237×3824×β=α/4+3808

Thus, the stuffing ratio a is as follows:

$$\begin{matrix}α = ( 236 / 237 \times 3824 \times β - 3808 ) \times 4 \\ = 236 / 237 \times 15296 \times β - 15232\end{matrix}$$

$$When β = 1 + y , \\ \begin{matrix}α = 236 / 237 \times 15296 - 236 / 237 \times 15296 \times y - 15232 \\ = - 0.5400844 + 15231.45992 \times y\end{matrix}$$

$$When α = 0 , \\ \begin{matrix}y = 0.5400844 / 15231.45992 \\ = 3.54585 \times 1 {e}^{- 5}\end{matrix}$$

Thus, α=0 (zero-stuffing) when the client signal frequency offset is 35.46 ppm.

In the first asynchronous mapping, where four channels of the 2.48832 Gb/s client signals are multiplexed, stuffing of 17.65 ppm always occurs even when the deviation of the 2.48832 Gb/s client signal is 0 ppm and the deviation of fs is 0 ppm.

In the second asynchronous mapping where four channels of the 9.95328 Gb/s client signals are multiplexed, stuffing of 35.46 ppm always occurs even when the deviation of the 9.95328 Gb/s client signal is 0 ppm and the deviation of fs is 0 ppm.

Thus, there is a maximum of ±40 ppm deviation depending on various combinations of the client signal frequency and fs. For example, if the frequency f1 of 9.95328 GHz is inputted with a deviation of +20 ppm and the deviation of the frequency fs is −15.46 ppm, the zero-stuffing status arises where no stuffing takes place.

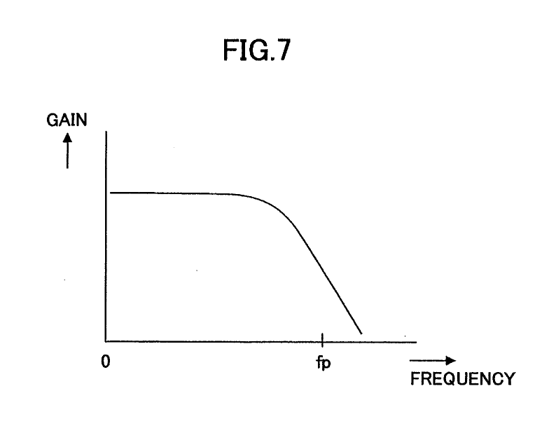

In cases where stuffing and destuffing take place, the influence of destuffing appears at frequencies higher than the band of the gain-frequency characteristics of the PLL 21 (0 to fp) depicted in FIG. 7. Thus, the influence of destuffing on the output client signal in the form of jitter can be prevented.

However, as the state of stuffing increasingly approaches the zero-stuffing status, the intervals of destuffing performed in the FIFO 20 at the separating end becomes longer, whereby the influence of destuffing begins to appear within the band of the gain-frequency characteristics of the PLL 21 depicted in FIG. 7 (0 to fp). As a result, the influence of destuffing on the output client signal in the form of jitter cannot be prevented, resulting in an output jitter that does not satisfy the ITU standards.

The band of the PLL 21 may be lowered by lowering the phase comparison frequency. However, this leads to an increase in a stationary phase error, resulting in an increase in the memory capacity of the FIFO 20 for transferring different clock frequencies.

Because the removal of OH and FEC at the demultiplexing end is performed on a frame by frame basis and at a high rate (such as in the 150 M band), the removal operation is outside the band of the PLL 21, so that no jitter is produced.

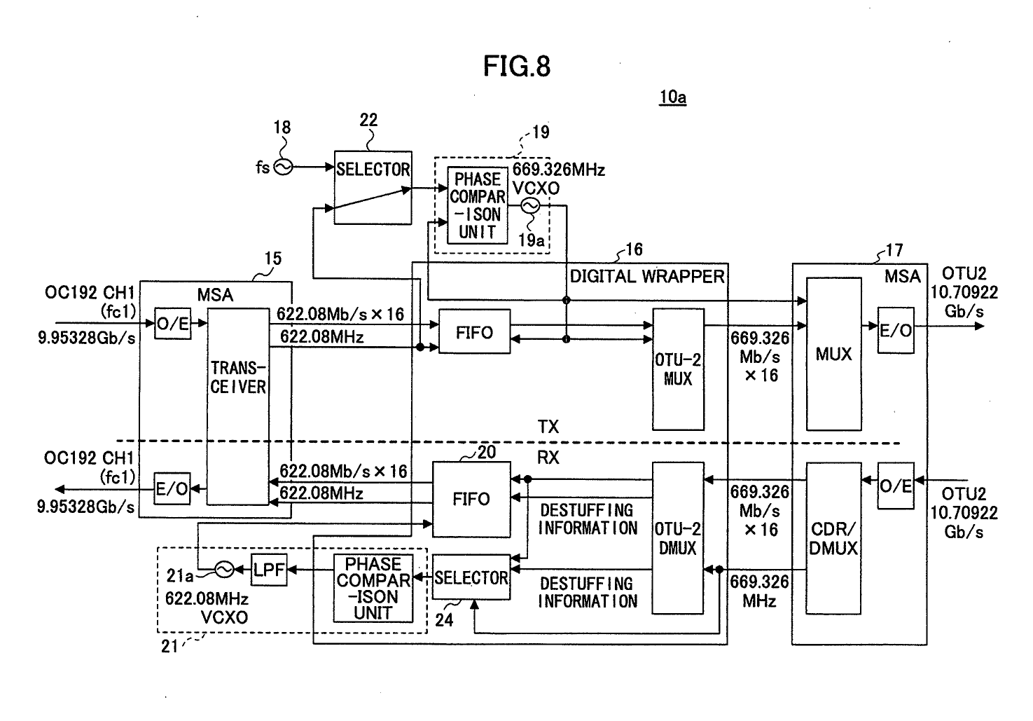

Hereafter, a case is considered in which one client channel is digitally wrapped in an asynchronous manner. When one channel of a client signal is digitally wrapped as depicted in FIGS. 5 and 6, normally an optical interface unit 10a depicted in FIG. 8 selects the frequency f1 of the client signal using a selector 22 and supplies it to a PLL 19 for slave synchronization, thus involving no stuffing.

However, there is a case where the reference clock fs from the oscillator 18 is selected by the selector 22 and supplied to the PLL 19 in order to synchronize the client signal with the reference clock fs. This involves an asynchronous clock transfer, and therefore stuffing is performed.

### <Third Asynchronous Mapping>

When 2.48832 Gb/s is mapped onto ODU1 in an asynchronous manner,

S=2.48832 Gb/s

T=3824×4/(2.48832 Gb/sx239/238)

where 3824×4 is the frame length of ODU1.

p=1 (the ratio is 1 because the payload of OPU1 can be used as is)

N=0 (ODU1 has no fixed stuffing bytes)

Substituting the above into equation (3 ) yields:

2.48832 Gb/sx3824×4/(2.48832 Gb/sx239/238)×β=α+15232

15232×β=α+15232

Thus, the stuffing ratio a is as follows:

α=15232 (β−1)

When β is 1, i.e., when yc=ys (client signal frequency=server signal frequency), α=0; namely, the zero-stuffing status arises where no stuffing is performed.

### <Fourth Asynchronous Mapping>

When 9.95328 Gb/s is mapped onto ODU2 in an asynchronous manner,

S=9.95328 Gb/s

T=3824×4/(9.95328 Gb/sx239/237)

where 3824×4 is the frame length of ODU2.

p=1 (the ratio is 1 because the payload of OPU2 can be used as is)

N=64 (ODU2 has 64 fixed stuffing bytes)

Substituting the above into equation (3) yields:

9.95328 Gb/sx3824×4/(9.95328 Gb/sx239/237)×β=α+15232−64

15168×β=α+15232−64

Thus, the stuffing ratio a is as follows:

$$\begin{matrix}α = 15168 \times β - 15232 + 64 \\ = 15168 ( β - 1 )\end{matrix}$$

When β is 1; namely, when yc=ys (client signal frequency=server signal frequency), α=0; namely, the zero-stuffing status arises where no stuffing is performed.

Thus, the zero-stuffing status arises when the deviation between the frequency f1 and the frequency fs is 0 ppm. In this case, the intervals of destuffing performed by the FIFO 20 at the separating end become so long that the influence of destuffing appears within the band of the gain-frequency characteristics of the PLL 21 (0 to fp) as depicted in FIG. 7. As a result, the jitter in the output client signal cannot be prevented, producing an output jitter that does not satisfy the ITU standards.

Referring now to the drawings, wherein like reference numerals designate identical or corresponding parts throughout the several views, embodiments of the present invention are described.

### <A. Digital Wrapper for Four Channels of Client Signal>

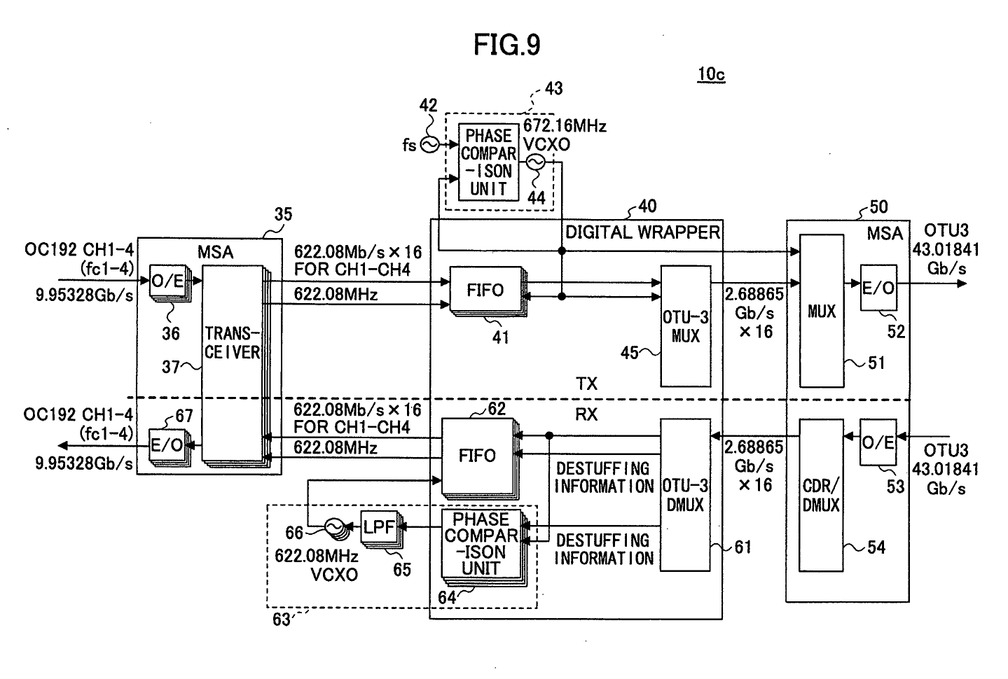

FIG. 9 depicts a block diagram of an optical interface unit 10c according to an embodiment of the present invention, which corresponds to the optical interface unit 10b depicted in FIG. 1. An MSA 35 is supplied with four channels of client signals of the transfer rate of 9.95328 Gb/s via a client line. The four channels of the client signals are asynchronous to one another. The client signals are opto-electrically converted by an O/E (optical/electronic converter) 36 and then supplied to a transceiver 37.

The transceiver 37 includes a CDR (Clock Data Recovery), an MUX (multiplexer), and a DMUX (demultiplexer), which are not depicted. The transceiver 37 extracts a clock (about 622.08 MHz) from each client signal using the CDR, demultiplexes each client signal into signals of the transfer rate of 622.08 Mb/sx16, and then supplies the separated signals to a digital wrapper 40.

In the digital wrapper 40, each client signal is written into a FIFO 41 using the extracted clock. The FIFO 41 reads each of the stored client signals in synchronism with a clock of a frequency (fs=672.16 MHz) outputted by an oscillator (VCXO) 44 of a PLL 43, which is synchronized with the clock of a fixed oscillator 42. The client signals that have been read are then supplied to an OTU3 MUX 45. The OTU3 MUX 45 multiplexes the four channels of the client signals into an OTU3 that is supplied to a MSA 50 as signals of the transfer rate of 2.68865 Gb/sx16. At this time, the difference between the frequency (fc1, fc2, fc3, fc4) of each client signal and the frequency fs (=9.95328 GHz) of the clock outputted by the fixed oscillator 42 is compensated for by stuffing synchronization. For example, when fs>f1, because the amount of data of f1 is small, excess bits (stuffing bits) are inserted.

The MSA 50 multiplexes the signals of the transfer rate of 2.68865 Gb/sx16 using an MUX 51. The multiplexed signal is then electro-optically converted by an E/O (electrical/optical convertor) 52 into an OTU3-format optical signal of the transfer rate of 43.01841 Gb/s that is supplied to the optical multiplexing unit 11a of the wavelength division multiplex/demultiplex apparatus 11 depicted in FIG. 1.

On the other hand, an OTU3-format optical signal supplied from the optical demultiplexing unit 11b of the wavelength division multiplex/demultiplex apparatus 11 is opto-electrically converted by an O/E 53 in the MSA 50. The resultant signal is supplied to a CDR/ DMUX 54 by which the signal is separated into signals of 2.68865 Gb/sx16.

The signals of the transfer rate of 2.68865 Gb/sx16 are demultiplexed into four channels of client signals by an OTU3 DMUX 61 in the digital wrapper 40, and the separated client signals are written in a FIFO 62 using an extracting clock of 2.68865 GHz. At this time, destuffing information of each client signal is also supplied to the FIFO 62.

The aforementioned extracting clock and the destuffing information are supplied to a phase comparison unit 64 of the PLL 63. In the phase comparison unit 64, a phase error signal having a deviation corresponding to the destuffing information is generated for each client signal, with reference to the extracted clock of 2.68865 GHz. The phase error signal is then supplied to an oscillator (VCXO) 66 via a low-pass filter 65.

The oscillator 66 generates a clock of a frequency having a certain deviation with respect to a frequency of 622.08 MHz in order to read each client signal from the FIFO 62. The individual client signals that have been read are multiplexed by the transceiver 37 in the MSA 35 into four channels of client signals of the transfer rate of 9.95328 Gb/s. The client signals are converted by an E/O 67 into optical signals that are outputted onto a client line.

In a conventional configuration, the fixed oscillator 18 may have a deviation within ±20 ppm. In accordance with the present embodiment, however, the frequency fs outputted by the fixed oscillator 42 has a deviation such that zero-stuffing does not occur.

A first condition in the second asynchronous mapping illustrated in FIG. 9, i.e., the multiplexing of the four channels of client signal of the transfer rate of 9.95328 Gb/s, is that the transmission channel (client line) has a signal deviation within ±20 ppm. A second condition is that the limit of stuffing in the NJO and PJO bytes in the OH of OPU, or a “stuffing limit”, is +197 ppm. A third condition is that a zero-stuffing-causing deviation occurs when the transmission channel frequency is higher than the frequency fs (=9.95328 GHz) of the fixed oscillator 42 by +35.46 ppm.

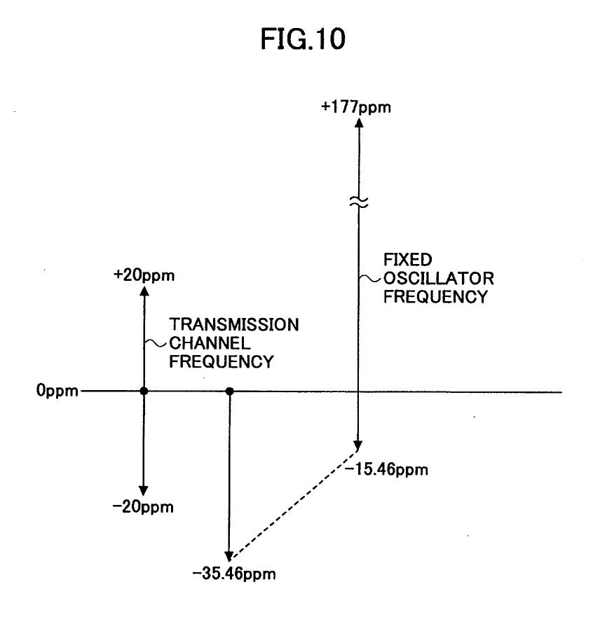

When the transmission channel frequency deviation is +20 ppm as depicted in FIG. 10, zero-stuffing takes place if the deviation in the frequency fs is −15.46 ppm. Thus, a frequency higher than fs(9.95328 GHz)−15.46 ppm is set as the lowest frequency of the fixed oscillator 42. When the transmission channel frequency deviation is −20 ppm, a frequency higher than fs−20 ppm by 197 ppm is the stuffing limit. Thus, fs+177 ppm is set as the highest frequency of the fixed oscillator 42. Thus, the fixed oscillator 42 is set using a frequency deviation range of −15.46 ppm<fs<+177 ppm as depicted in FIG. 10, such as, for example, −15.46 ppm<fs<+55.46 ppm, taking into consideration the individual variations of the fixed oscillator 42 and environmental variations, such as temperature variations.

Similarly, the first condition in the case of the first asynchronous mapping involving the multiplexing of four channels of client signals of 2.48832 Gb/s is that the transmission channel has a signal deviation within ±20 ppm.

The second condition is that the stuffing limit of the NJO and PJO bytes in the OH of OPU is +149 ppm. The third condition is that the zero-stuffing causing deviation occurs when the transmission channel frequency is higher than the frequency fs (=2.48832 GHz) of the fixed oscillator 42 by +17.65 ppm.

When the transmission channel frequency deviation is +20 ppm, zero-stuffing occurs when the frequency fs is lower by 17.65 ppm. Thus, a frequency higher than fs(2.48832 GHz)+2.35 ppm is set as the lowest frequency of the fixed oscillator 42. When the transmission channel frequency deviation is −20 ppm, a frequency higher than fs−20 ppm by 149 ppm is the stuffing limit. Thus, fs(2.48832 GHz)+129 ppm is set as the highest frequency of the fixed oscillator 42.

Thus, the fixed oscillator 42 is set using a frequency deviation range of +2.35 ppm<fs<+129 ppm, such as, for example, +2.35 ppm<fs<+42.35 ppm, taking into consideration the individual variations of the fixed oscillator 42 and environmental variations, such as temperature variations. In this way, zero-stuffing can be avoided and jitter in the output client signal can be prevented.

### <B. Digital Wrapper For One Channel of Client Signal>

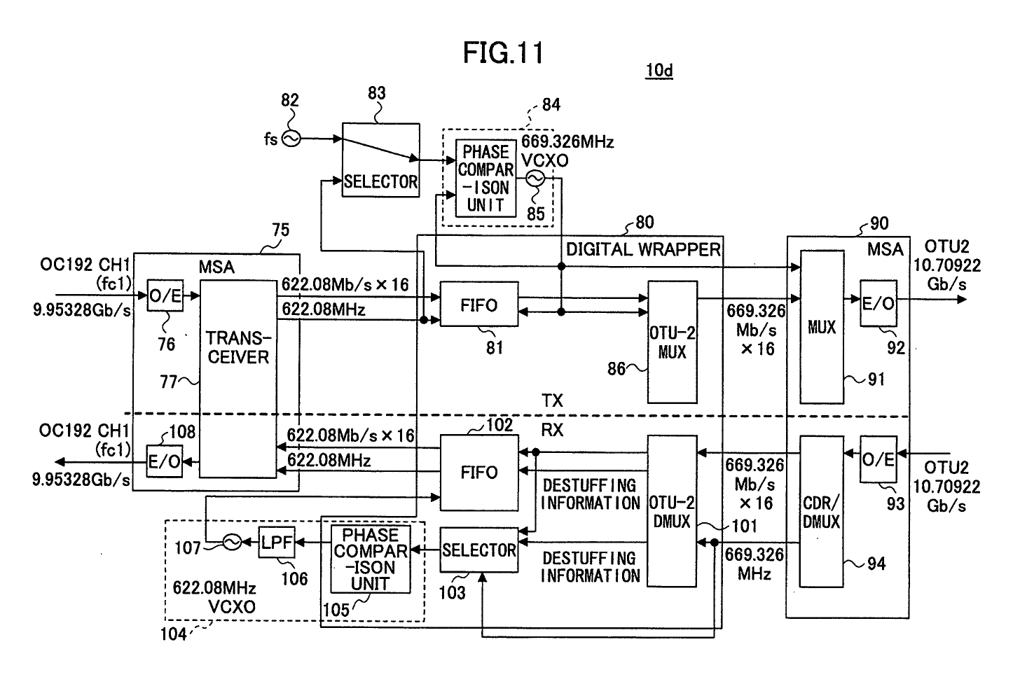

FIG. 11 depicts a block diagram of an optical interface unit 10d according to a second embodiment of the present invention, which corresponds to the optical interface unit 10a depicted in FIG. 1. An MSA 75 is supplied with one channel of a client signal of the transfer rate of 9.95328 Gb/s via a client line. The client signal is opto-electrically converted by an O/E 76 and then supplied to a transceiver 77.

The transceiver 77 includes a CDR, a MUX, and a DMUX, which are not depicted. The transceiver 77 extracts a clock (about 622.08 MHz) from each client signal using the CDR, and demultiplexes the client signal into signals of the transfer rate of 622.08 Mb/sx16. The separated signals are supplied to a digital wrapper 80. In a normal mode, a frequency f1 of the client signal is selected by a selector 83 and supplied to a PLL 84 for slave synchronization. In a specific mode, a reference clock fs from the oscillator 82 is selected by the selector 83 and supplied to the PLL 84 in order to synchronize each client signal with the reference clock fs.

In the digital wrapper 80, the client signal is written in a FIFO 81 using the extracted clock. In the specific mode, the FIFO 81 reads each stored client signal in synchronism with a clock of a frequency (fs=669.326 MHz) outputted by an oscillator (VCXO) 85 of the PLL 84, which is synchronized with the clock of the fixed oscillator 82. The client signal is then supplied to an OTU2 MUX 86.

In the OTU2 MUX 86, the client signals are multiplexed into an OTU2 of the transfer rate of 669.326 Mb/sx16 that are supplied to an MSA 90. At this time, the difference between the frequency (fc1) of the client signal and the frequency fs (=9.95328 GHz) of the clock outputted by the fixed oscillator 82 is compensated for by stuffing synchronization. For example, when fs>f1, the amount of data of f1 is small, so that stuffing is performed to insert excess bits (stuffing bits).

In the MSA 90, the signals of the transfer rate of 669.326 Mb/s are multiplexed by an MUX 91 and then electro-optically converted by an E/O (electrical/optical convertor) 52, producing an OTU2-format optical signal of 10.70922 Gb/s. The optical signal is then supplied to the optical multiplexing unit 11a of the wavelength division multiplex/demultiplex apparatus 11 depicted in FIG. 1.

On the other hand, an OTU2-format optical signal supplied from the optical demultiplexing unit 11b of the wavelength division multiplex/demultiplex apparatus 11 is opto-electrically converted by an O/E 93 in the MSA 90 and then supplied to a CDR/DMAX 94, where the signal is separated into signals of the transfer rate of 669.326 Mb/sx16.

The signals of the transfer rate of 669.326 Mb/s are made into one channel of client signals by an OTU2 DMUX 101 in the digital wrapper 80. The client signals are then written into a FIFO 102 using an extracting clock of a frequency of 669.326 MHz. At this time, destuffing information of each client signal is also supplied to the FIFO 102.

A selector 103 is supplied with the extracting clock and the destuffing information from the OTU2 DMUX 101 and also with the signal of the transfer rate of 669.326 Mb/s from the CDR/DMAX 94. The selector 103 selects the signal of the transfer rate of 669.326 Mb/s in a normal mode, while selecting the extracting clock and the destuffing information in a specific mode. The selected signal is supplied to a phase comparison unit 105 of a PLL 104.

The phase comparison unit 105 in the specific mode generates a phase error signal having a deviation based on the destuffing information for each client signal, with reference to the extracting clock of the frequency of 669.326 MHz. In the normal mode, the phase comparison unit 105 generates a phase error signal based on the frequency of 669.326 MHz. The phase error signal is supplied to an oscillator (VCXO) 107 via a low-pass filter 106.

The oscillator 107 generates a clock of a frequency with a certain deviation with reference to the frequency 669.326 MHz, in order to read each client signal from the FIFO 102. The individual client signals are made into one channel of client signals of the transfer rate of 9.95328 Gb/s by the transceiver 77 in the MSA 75. The resultant client signals are converted into optical signals by an E/O 108 and then outputted onto a client line.

In accordance with the present embodiment, the frequency fs of the fixed oscillator 82 is varied from the client signal frequency fl. Namely, the deviation in the fixed oscillator 82 is set between +20 ppm<fs<+60 ppm, for example, so that zero-stuffing does not take place when the transmission channel frequency deviation is within ±20 ppm. In this way, zero-stuffing can be avoided and the development of jitter in the output client signal can be prevented. While in the above embodiment one channel of a client signal of 9.95328 Gb/s is digitally wrapped, the embodiment may be adapted for digitally wrapping one channel of a client signal of 2.48832 Gb/s.

### <C. Varying fs Depending on the Transmission Channel Frequency>

In the first and the second embodiments, zero-stuffing is prevented by shifting the frequency of the fixed oscillator 42 or 82. In a third embodiment described below, zero-stuffing is prevented by varying the frequency fs depending on the transmission channel frequency.

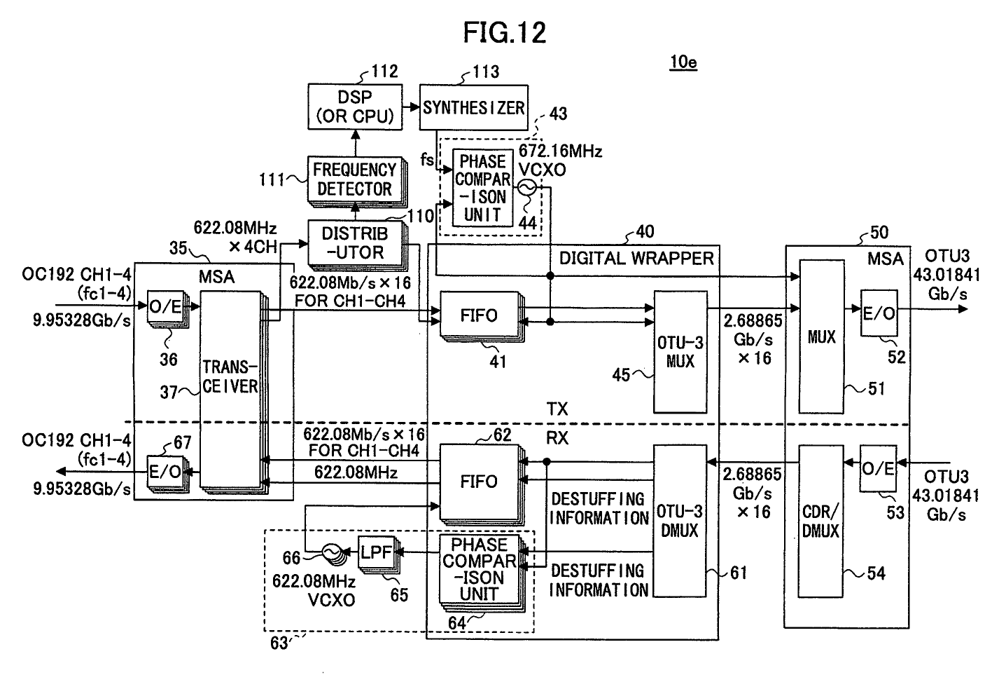

FIG. 12 depicts a block diagram of an optical interface unit 10e according to the third embodiment of the present invention, which corresponds to the optical interface unit 10b depicted in FIG. 1. An MSA 35 is supplied with four channels of client signals of the transfer rate of 9.95328 Gb/s via a client line. The four channels of client signal are asynchronous to one another.

The client signals are opto-electrically converted by an O/E 36 and then supplied to a transceiver 37. The transceiver 37, which includes a CDR, a MUX, and a DMUX which are not depicted, extracts a clock (about 622.08 MHz) from each client signal using the CDR, and demultiplexes each client signal into the transfer rate of 622.08 Mb/sx16 which are supplied to a digital wrapper 40.

In the digital wrapper 40, each client signal is written in an FIFO 41 using the extracted clock. The FIFO 41 reads each stored client signal in synchronism with a clock of a frequency (672.16 MHz) outputted by an oscillator (VCXO) 44 of a PLL 43, which is synchronized with the clock of a synthesizer 113, and supplies the client signal to an OTU3 MUX 45. In the OTU3 MUX 45, four channels of the client signals are multiplexed into an OTU3 that is supplied to an MSA 50 as signals of the transfer rate of 2.68865 Gb/sx16. At this time, the difference between the frequency (fc1, fc2, fc3, fc4) of each client signal and the frequency (fs=9.95328 GHz) of the clock outputted by the synthesizer 113 is compensated for by stuffing synchronization.

The clock of each client signal extracted by the CDR in the transceiver 37 is distributed by a distributor 110 to a frequency detector 111. The frequency information of each client signal detected by the frequency detector 111 is then supplied to a DSP (digital signal processor) or CPU (central processing unit) 112. The DSP (or CPU) 112 determines the client signal having the maximum frequency deviation, calculates a frequency that does not cause zero-stuffing with respect to the determined client signal frequency, and varies the frequency fs outputted by the synthesizer 113 in accordance with the calculated frequency.

In the MSA 50, the signals of the transfer rate of 2.68865 Gb/sx16 are multiplexed by a MUX 51. The multiplexed signal is electro-optically converted by an E/O (electrical/optical convertor) 52 into an OTU3-format optical signal of the transfer rate of 43.01841 Gb/s that is supplied to the optical multiplexing unit 11a of the wavelength division multiplex/demultiplex apparatus 11 depicted in FIG. 1.

On the other hand, an OTU3-format optical signal supplied from the optical demultiplexing unit 11b of the wavelength division multiplex/demultiplex apparatus 11 is opto-electrically converted by an O/E 53 in the MSA 50 and then supplied to a CDR/DMAX 54, where the converted signal is separated into signals of the transfer rate of 2.68865 Gb/sx16.

The signals of the transfer rate of 2.68865 Gb/sx16 are separated by an OTU3 DMUX 61 in the digital wrapper 40 into four channels of client signals that are written into an FIFO 62 using an extracting clock of a frequency 2.68865 GHz. At this time, destuffing information of each client signal is also supplied to the FIFO 62.

The aforementioned extracting clock and the destuffing information are supplied to a phase comparison unit 64 of a PLL 63. The phase comparison unit 64 generates a phase error signal having a deviation based on the destuffing information for each client signal, with reference to the extracting clock of the frequency 2.68865 GHz. The phase error signal is then supplied via a low-pass filter 65 to an oscillator (VCXO) 66.

The oscillator 66 generates a clock having a frequency with a certain deviation with respect to a frequency 622.08 MHz in order to read each client signal from the FIFO 62. The client signals that have been read from the FIFO 62 are multiplexed by the transceiver 37 in the MSA 35 into four channels of client signals of the transfer rate of 9.95328 Gb/s. The client signals are then converted by an E/O 67 into optical signals that are outputted onto a client line.

In accordance with the present embodiment, the client signal having the maximum frequency deviation is determined, a frequency that does not cause zero-stuffing with regard to the frequency of the determined client signal is calculated, and then the frequency fs of the synthesizer 113 is varied in accordance with the calculated frequency. In this way, zero-stuffing can be avoided and the development of jitter in the output client signal can be prevented. While in the foregoing embodiment, multiplexing/ demultiplexing of the four channels of client signals of 9.95328 Gb/s has been described, the embodiment may be adapted for multiplexing/ demultiplexing four channels of client signals of 2.48832 Gb/s.

In the embodiment where one channel of client signal is digitally wrapped, jitter in the output client signal may be prevented by avoiding zero-stuffing in the manner described with reference to FIG. 12. Specifically, in this case, the clock of a client signal extracted by the CDR is distributed by the distributor 110 to the frequency detector 111, and the frequency information of the client signal that is detected by the frequency detector 111 is supplied to the DSP 112. The DSP 112 calculates a frequency that does not cause zero-stuffing based on the frequency information of the client signal, and the synthesizer 113, which may include a general-purpose variable oscillator, is controlled to change the frequency fs accordingly.

In the foregoing embodiment, the frequency detector 111 is used as a frequency detection unit, and the DSP 112 is used as an oscillating frequency varying unit.

Thus, the present invention has been described herein with reference to preferred embodiments thereof. While the present invention has been shown and described with particular examples, it should be understood that various changes and modification may be made to the particular examples without departing from the broad spirit and scope of the present invention as defined in the claims. That is, the scope of the present invention is not limited to the particular examples and the attached drawings.

What is claimed is:

1. An optical interface method comprising:
producing a digital wrapper signal by synchronizing a client signal that is inputted via an optical transmission channel with an oscillating frequency of a fixed oscillator;
returning the digital wrapper signal back into the client signal; and
outputting the client signal obtained from the digital wrapper signal by the returning onto the optical transmission channel,
wherein the oscillating frequency of the fixed oscillator is set higher than a frequency of the client signal in the optical transmission channel.

2. An optical interface apparatus comprising:
a fixed oscillator configured to generate an oscillating frequency; and
a digital wrapper unit configured to produce a digital wrapper signal by synchronizing a client signal inputted via an optical transmission channel with the oscillating frequency generated by the fixed oscillator, and configured to return the digital wrapper signal back into the client signal that is outputted onto the optical transmission channel,
wherein the oscillating frequency of the fixed oscillator is set higher than a frequency of the client signal on the optical transmission channel.

3. The optical interface apparatus according to claim 2, wherein the client signal inputted via the optical transmission channel includes a plurality of channels of the client signal that are asynchronous to one another.

4. The optical interface apparatus according to claim 2, wherein the client signal inputted via the optical transmission channel includes a single channel of the client signal.

5. The optical interface apparatus according to claim 3, wherein the client signal inputted via the optical transmission channel has a frequency deviation within ±20 ppm with respect to the frequency of 9.95328 GHz,
wherein the plurality of channels of the client signal include four channels of the client signal that are digitally wrapped into a first optical channel transport unit, and
wherein a frequency deviation of the oscillating frequency of the fixed oscillator is set in a range of −15.46 ppm or more and +177 ppm or less.

6. The optical interface apparatus according to claim 3, wherein the client signal inputted via the optical transmission channel has a frequency deviation within ±20 ppm with respect to the frequency of 2.48832 MHz,
wherein the plurality of channels of the client signal include four channels of the client signal that are digitally wrapped into a second optical channel transport unit, and
wherein a frequency deviation of the oscillating frequency of the fixed oscillator is set in a range of +2.35 ppm or more and +129 ppm or less.

7. The optical interface apparatus according to claim 4, wherein the single channel of the client signal inputted via the optical transmission channel has a frequency deviation within ±20 ppm with respect to the frequency of 9.95328 MHz,
wherein the single channel of the client signal is digitally wrapped into a second optical channel transport unit, and
wherein a frequency deviation of the oscillating frequency of the fixed oscillator is set to be +20 ppm or more.

8. The optical interface apparatus according to claim 4, wherein the single channel of the client signal inputted via the optical transmission channel has a frequency deviation within ±20 ppm with respect to the frequency of 2.48832 MHz,
wherein the single channel of the client signal is digitally wrapped into a third optical channel transport unit, and
wherein a frequency deviation of the oscillating frequency of the fixed oscillator is set to be +20 ppm or more.

9. An optical interface apparatus comprising:
an oscillator configured to generate an oscillating frequency;
a digital wrapper configured to produce a digital wrapper signal by synchronizing a client signal inputted via an optical transmission channel with the oscillating frequency of the oscillator, and configured to return the digital wrapper back into the client signal that is outputted onto the optical transmission channel;
a frequency detection unit configured to detect a frequency of the client signal inputted via the optical transmission channel; and
an oscillating frequency varying unit configured to vary the oscillating frequency of the oscillator depending on the frequency of the client signal detected by the frequency detection unit,
wherein the oscillating frequency of the oscillator is set to be higher than the frequency of the client signal on the optical transmission channel.
